(19) United States
(12) Patent Application Publication
(10) Pub. No.: US 2025/0040526 A1
(43) Pub. Date: Feb. 6, 2025

(54) LURE

(71) Applicant: Junmin Xu, Ningbo (CN)

(72) Inventor: Junmin Xu, Ningbo (CN)

(21) Appl. No.: 18/678,317

(22) Filed: May 30, 2024

(30) Foreign Application Priority Data
Aug. 1, 2023 (CN) 202322043421X

(51) Int. Cl. A01K 85/18; A01K 85/00

(52) U.S. Cl. CPC A01K 85/18; A01K 85/1837; A01K 85/1847

(57) ABSTRACT

A lure comprises a bionic fish body and a fish tail, the bionic fish body and the fish tail are connected through connecting plates, the bionic fish body is composed of a first shell and a second shell that are connected to each other, a cavity is arranged inside the bionic fish body, several counterweight slots are evenly arranged on the bionic fish body close to the belly of the fish, counterweight blocks are placed in the counterweight slots; the imitated fish body is used to lure big fish to attack decisively, thereby making them bit the hook, so that the artificial bait fits the small fish to the greatest extent in terms of shape and sense, thereby increasing the success rate of catching big fish.

### 1. TECHNICAL FIELD

The invention relates to the technical field of fishing tools, in particular to a lure.

### 2. BACKGROUND ART

Fishing has always been one of the outdoor sports loved by people of all ages. Traditional fishing uses live bait to attract fish, and when the fish prey on the bait, the hook catches them, helping anglers successfully land the fish. However, this type of fishing often requires a certain level of technical experience to increase the probability of successfully catching big fish and allow anglers to enjoy the fun of fishing. However, due to the lack of technical experience gained from long-term training, coupled with the inflexibility of traditional fishing methods that are usually fixed in a certain area, most people gradually lose interest in fishing. With the continuous advancement of technology, some fishing tools made using bionic principles have gradually emerged on the market. These tools are convenient to carry and have strong flexibility and mobility. One common example is the lure fishing tackle, which does not use live bait but instead employs artificial bait made of plastic and metal. This artificial bait imitates the shape of small fish to attract larger fish, achieving the dual benefits of being environmentally friendly and reusable, while also reducing the cost of live bait. However, how to make the artificial bait even more realistic, vivid, and lively, and increase the probability of catching big fish, has been a consistent research focus for technicians in this field.

### 3. SUMMARY OF THE INVENTION

The technical problem to be solved by the invention is to overcome the defect of the above technology and provide a new type of lure.

To solve the above technical problem, the invention provides the following technical scheme: the lure comprises a bionic fish body and a fish tail, the bionic fish body and the fish tail are connected through connecting plates, the bionic fish body is composed of a first shell and a second shell that are connected to each other, a cavity is arranged inside the bionic fish body, several counterweight slots are evenly arranged on the bionic fish body close to the belly of the fish, counterweight blocks are placed in the counterweight slots;
slots are arranged at one end of the bionic fish body near the fish tail, one end of the connecting plates extends into the slots, and the other end of the connecting plates is movably hinged with the rotating rod arranged inside the fish tail;
the connecting plates are provided with strip slots along the axis direction on the board bodies located inside the slots, the body of each strip slot is provided with a plurality of circular slot holes;
the tail of the bionic fish body is provided with a jack that intersects perpendicularly with the slots, a locking post is arranged inside the jack, one end of the locking post extends downward to the outside of the bionic fish body, the body of the locking post is provided with annular grooves located below the connecting plates, the locking post passes through the interiors of the circular slot holes.

As an improvement, a spring is arranged inside the jack above the locking post.

As an improvement, a ring is installed on the bionic fish body near the fish head.

As an improvement, the first shell and the second shell are fixedly connected through bolts arranged at the edge of the shells.

As an improvement, a flow baffle is arranged at the fish mouth of the bionic fish body.

As an improvement, fishhooks are arranged at the lower part of the bionic fish body and fish tail.

As an improvement, one end of the bionic fish body near the fish tail is set as a V-shaped groove structure.

As an improvement, the diameter of the locking post is slightly smaller than the inner diameter of the circular slot holes, and the diameter of the annular grooves is slightly smaller than the width of the strip slots.

The advantageous effects of the invention are as follow:

the imitated fish body is used to lure big fish to attack decisively, thereby making them bit the hook, so that the artificial bait fits the small fish to the greatest extent in terms of shape and sense, thereby increasing the success rate of catching big fish.

### 4. BRIEF DESCRIPTION OF ACCOMPANY DRAWINGS

FIG. 1 is a schematic diagram of the structure of the lure;

FIG. 2 is a schematic diagram of the structure of lure from the top view;

FIG. 3 is a cross-sectional view of the structure of A-A;

FIG. 4 is a schematic diagram of the internal structure of the lure;

FIG. 5 is a schematic diagram of the connection structure from a first perspective;

FIG. 6 is a schematic diagram of the connection structure from a second perspective.

As shown in the figures: 1 bionic fish body, 101 first shell, 102 second shell, 103 cavity, 104 V-shaped groove, 2 fish tail, 3 slot, 4 connecting plate, 401 strip slot, 402 circular slot hole, 5 locking post, 501 annular groove, 6 spring, 7 jack, 8 counterweight slot, 9 counterweight block, 10 flow baffle, 11 ring, 12 rotating rod, 13 fishhook.

### 5. SPECIFIC EMBODIMENT OF THE INVENTION

In order to make the objects, technical schemes and advantages of the embodiments of the invention clearer, the technical schemes in the embodiments of the invention will be clearly and completely described below in combination with the accompanying drawings in the embodiments of the invention, obviously, the described embodiments are some, but not all embodiments of the invention. The components of the embodiments of the invention generally described and illustrated in the drawings herein may be arranged and designed in a variety of different configurations.

In the description of the invention, it should be understood that the orientation or positional relationship indicated by the terms “center”, “upper”, “lower”, “left”, “right”, “vertical”, “horizontal”, “inner”, “outer” and so on are based on the orientation or positional relationship shown in the accompanying drawings, or the orientation or positional relationship that product of the invention is usually placed in when it is used, only for the convenience of describing the invention and simplifying the description, rather than indicating or implying that the indicated device or element must have a specific orientation, as well as a specific orientation structure and operation, therefore, it should not be construed as a limitation of the invention. In addition, the terms of “first”, “second”, “third” and so on are only used to differentiate the description, and should not be construed as indicating or implying relative importance.

In addition, if the terms “horizontal”, “vertical”, “overhanging” and other terms appear, it does not mean that the component is required to be absolutely horizontal or overhanging, but can be slightly inclined. For example, “horizontal” simply means that its direction is more horizontal than “vertical”, it does not mean that the structure must be completely horizontal, but can be slightly inclined.

In the description of the invention, “a plurality of” means at least two.

In the description of the invention, it should also be noted that the terms of “arrange”, “install”, “link”, “connect”, etc., should be generally understood unless there are specific restrictions or stipulations, for example, the “connect” may refer to fixed connection, detachable connection or integral connection; the “connect” may also refer to mechanical connection or electrical connection; the means of “connect” may be directly connected or indirectly connected through an intermediate medium, and may be internal communication between the two elements. For those skilled in the art, the specific meaning of the above terms in the invention can be understood according to the specific situation.

The following is a further detailed description of the lure of the invention in combination with the accompanying drawings.

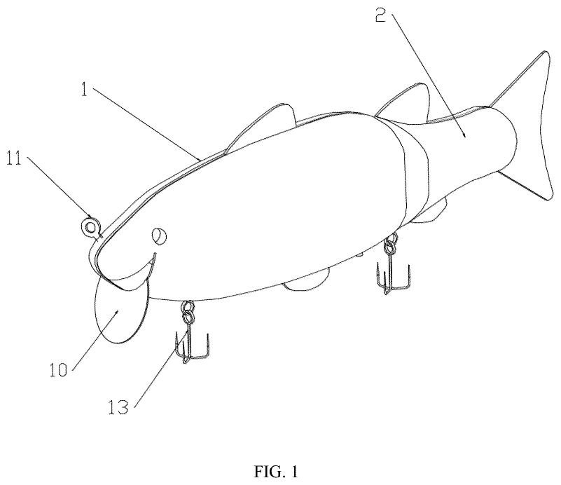

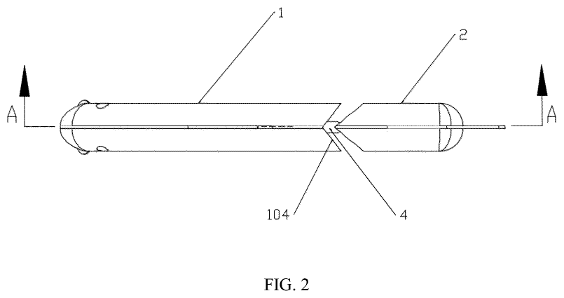

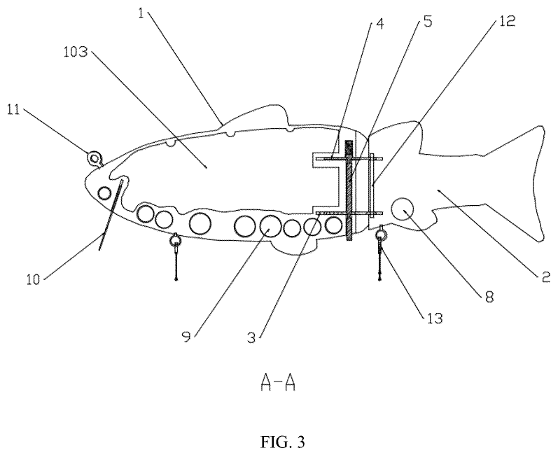

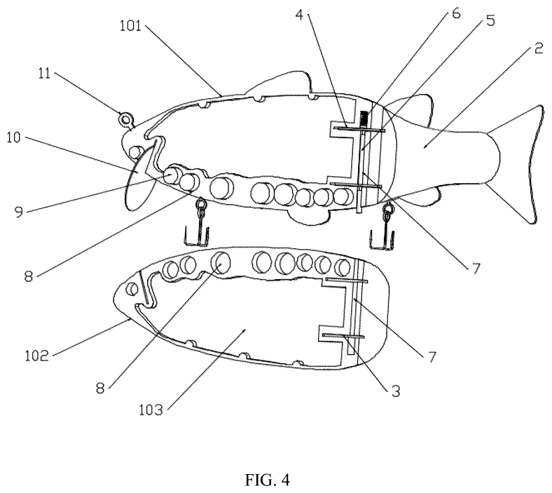

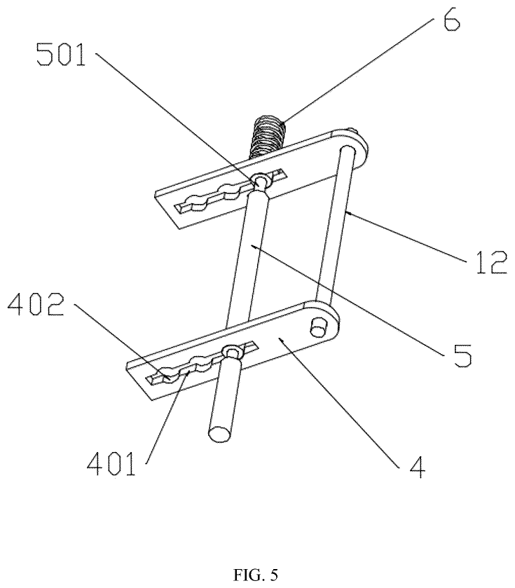

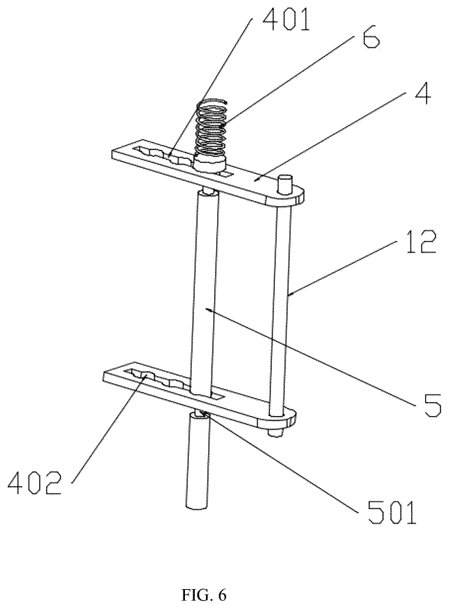

Combined with FIG. 1-FIG. 6, the lure comprises a bionic fish body 1 and a fish tail 2, the bionic fish body 1 and the fish tail 2 are connected through connecting plates 4, the bionic fish body 1 is composed of a first shell 101 and a second shell 102 that are connected to each other, a cavity 103 is arranged inside the bionic fish body 1, several counterweight slots 8 are evenly arranged on the bionic fish body 1 close to the belly of the fish, counterweight blocks 9 are placed in the counterweight slots 8;
slots 3 are arranged at one end of the bionic fish body 1 near the fish tail 2, one end of the connecting plates 4 extends into the slots 3, and the other end of the connecting plates 4 is movably hinged with the rotating rod 12 arranged inside the fish tail 2;
the connecting plates 4 are provided with strip slots 401 along the axis direction on the board bodies located inside the slots 3, the body of each strip slot 401 is provided with a plurality of circular slot holes 402;
the tail of the bionic fish body 1 is provided with a jack 7 that intersects perpendicularly with the slots 3, a locking post 5 is arranged inside the jack 7, one end of the locking post 5 extends downward to the outside of the bionic fish body 1, the body of the locking post 5 is provided with annular grooves 501 located below the connecting plates 4, the locking post 5 passes through the interiors of the circular slot holes 402.

As a preferred implementation of this embodiment, a spring 6 is arranged inside the jack 7 above the locking post 5.

As a preferred implementation of this embodiment, a ring 11 is installed on the bionic fish body 1 near the fish head.

As a preferred implementation of this embodiment, the first shell 101 and the second shell 102 are fixedly connected through bolts arranged at the edge of the shells.

As a preferred implementation of this embodiment, a flow baffle 10 is arranged at the fish mouth of the bionic fish body 1.

As a preferred implementation of this embodiment, fishhooks 13 are arranged at the lower part of the bionic fish body 1 and fish tail 2.

As a preferred implementation of this embodiment, one end of the bionic fish body 1 near the fish tail 2 is set as a V-shaped groove 104 structure.

As a preferred implementation of this embodiment, the diameter of the locking post 5 is slightly smaller than the inner diameter of the circular slot holes 402, and the diameter of the annular grooves 501 is slightly smaller than the width of the strip slots 401.

During specific implementation of this invention, the first shell 101 and the second shell 102, which are connected to each other by bolts, form the bionic fish body 1, one end of the bionic fish body 1 near the fish tail 2 is set as a V-shaped groove 104 structure, the bionic fish body 1 and the fish tail 2 are connected through connecting plates 4, the connecting plates 4 are provided with strip slots 401 along the axis direction on the board bodies located inside the slots 3, the body of each strip slot 401 is provided with a plurality of circular slot holes 402; when adjusting the distance between the bionic fish body 1 and the fish tail 2, the locking post 5 protruding from the fish belly of the bionic fish body 1 is pressed with your hand, the annular grooves 501 at the body of the locking post 5 are inserted into the circular slot holes 402; then the fish tail 2 is pulled by hand, the connecting plates 4 are moved along the inside of the slots 3 until the circular slot holes 402 at the desired adjustment distance are aligned with the locking post 5; the locking post 5 is released, the locking post is inserted into the circular slot holes 402, the locking post and the connecting plates are fixed and locked.

According to the need for counterweight, counterweight blocks 9 are placed in the counterweight slots 8 to adjust the tilt angle of the bionic fish body 1 in the water.

The invention and its embodiments are described above, this description is not restrictive, and what is shown in the accompanying drawing is only one of the embodiments of the invention, and the actual structure is not limited to this. All in all, if those skilled in the art receives its enlightenment, without deviating from the object of the invention, and without creatively designing structures and embodiments similar to the technical scheme of the invention shall fall within the protection scope of the invention.

1. A lure comprises a bionic fish body and a fish tail, the bionic fish body and the fish tail are connected through connecting plates, the bionic fish body is composed of a first shell and a second shell that are connected to each other, a cavity is arranged inside the bionic fish body, several counterweight slots are evenly arranged on the bionic fish body close to the belly of the fish, counterweight blocks are placed in the counterweight slots;
slots are arranged at one end of the bionic fish body near the fish tail, one end of the connecting plates extends into the slots, and the other end of the connecting plates is movably hinged with the rotating rod arranged inside the fish tail;
the connecting plates are provided with strip slots along the axis direction on the board bodies located inside the slots, the body of each strip slot is provided with a plurality of circular slot holes;
the tail of the bionic fish body is provided with a jack that intersects perpendicularly with the slots, a locking post is arranged inside the jack, one end of the locking post extends downward to the outside of the bionic fish body, the body of the locking post is provided with annular grooves located below the connecting plates, the locking post passes through the interiors of the circular slot holes.

2. The lure of claim 1, a spring is arranged inside the jack above the locking post.

3. The lure of claim 1, a ring is installed on the bionic fish body near the fish head.

4. The lure of claim 1, the first shell and the second shell are fixedly connected through bolts arranged at the edge of the shells.

5. The lure of claim 1, a flow baffle is arranged at the fish mouth of the bionic fish body.

6. The lure of claim 1, fishhooks are arranged at the lower part of the bionic fish body and fish tail.

7. The lure of claim 1, one end of the bionic fish body near the fish tail is set as a V-shaped groove structure.

8. The lure of claim 1, the diameter of the locking post is slightly smaller than the inner diameter of the circular slot holes, and the diameter of the annular grooves is slightly smaller than the width of the strip slots.
